(19) United States
(12) Patent Application Publication
(10) Pub. No.: US 2023/0316393 A1
(43) Pub. Date: Oct. 5, 2023

(54) DETERMINING RECOGNIZED USER ACTIVITIES FOR A THIRD-PARTY RISK GENERATOR INTEGRATED WITHIN AN APPLICATION

(71) Applicant: Chime Financial, Inc., San Francisco, CA (US)

(72) Inventors: Cole Bennett, Orinda, CA (US); Jacqueline Chien, San Francisco, CA (US); James Sheak, San Mateo, CA (US); Siqi Wang, San Jose, CA (US); Taylor Lentz, South Lake Tahoe, CA (US); Vanisha Wason, San Francisco, CA (US); Xuan Wang, Sunnyvale, CA (US); Yijie Li, Sunnyvale, CA (US); Ziad Abdo, Oakland, CA (US)

(21) Appl. No.: 17/657,682

(22) Filed: Apr. 1, 2022

(51) Int. Cl. G06Q 40/02

(52) U.S. Cl. CPC G06Q 40/025

(57) ABSTRACT

The disclosure describes embodiments of systems, methods, and non-transitory computer readable storage media that determine and display recognized user activities for an integrated risk assessment value generator from a third-party system. For example, the disclosed systems can analyze user activities of a user account to determine recognized user activities recognized by a third-party risk assessment value generator from a third-party risk assessment system. The disclosed systems can further display, within an application, the determined recognized user activities from the user account and a selectable element to initiate an integration of the user account with the third-party risk assessment system to access functionalities that can improve a user risk assessment value. In addition, the disclosed systems can integrate the user account with the third-party risk assessment system within the same application to provide user activities from the user account to the third-party risk assessment system to generate a risk assessment value.

### BACKGROUND

Recent years have seen a significant development in systems that utilize web-based and mobile-based applications to manage user accounts and digital information for user accounts in real time. For example, many conventional applications provide various graphical user interfaces (GUIs) to present digital information and options to client devices. In many cases, this includes determining or calculating account-specific values, logging and displaying user activities, and presenting account-specific risk assessments through the web-based and mobile-based applications. Although conventional systems attempt to determine and communicate such digital information to user accounts on web-based and mobile-based applications, such conventional systems face a number of technical shortcomings. Indeed, many conventional systems provide access to outsourced digital information and functions in an inefficient and rigid manner while also failing to accurately pinpoint relationships between the outsourced digital information and information available to the conventional systems.

For example, many conventional systems utilize (or require) an inefficient number of navigational steps to access and display digital information and functionalities of a third-party system. To illustrate, in place of information and functionalities of a third-party system, many conventional systems often provide web links within web-based and/or mobile-based applications that redirect users to web-based and/or mobile-based applications of the third-party system. Then, in such conventional systems, redirected users may access digital information and functionalities of the third-party system via the separate web-based and/or mobile-based application of the third-party system (from the web-based and/or mobile-based application of the conventional system). In addition to the inefficient utilization of computing resources by having multiple web-based and/or mobile-based applications operating, many conventional systems often also incur an inefficient amount of computing resources due to users logging in to access the digital information and the functionalities of the third-party system within the redirected page.

In addition, many conventional systems are often limited to rigid graphical user interface experiences that are unable to provide digital information and functionalities of a third-party system within web-based and/or mobile-based applications of the conventional system. For example, as mentioned above, many conventional systems redirect users to applications of the third-party system to access digital information and functionalities of the third-party system. In addition, when utilizing a third-party system to calculate user account specific values, conventional systems often treat computer-based models from the third-party system as a black box mechanism in which the conventional systems provide information and receive a calculated output based on the information. Oftentimes, such conventional systems are unable to easily provide details on user account specific data that affects the third-party system. In some cases, these conventional systems attempt to provide details that affect the third-party system, however, are unable to succinctly fit the details in the limited screen spaces of many mobile devices.

In addition to being inflexible, many conventional systems cannot accurately determine and present user account specific data that affects the black box mechanisms of computer-based models of third-party systems. In particular, oftentimes, conventional systems simply provide data to a third-party system and present outputs provided by the third-party system. These conventional systems are unable to accurately determine and pinpoint relations between data of a user account (of the conventional systems) and the inaccessible computer-based models of third-party systems.

### SUMMARY

The disclosure describes one or more embodiments of systems, methods, and non-transitory computer readable media that provide benefits and solve one or more of the foregoing or other problems by determining and displaying recognized user activities for an integrated risk assessment value generator from a third-party system. For example, the disclosed systems can analyze user activities of a user account corresponding to the disclosed systems to determine recognized user activities that are potentially recognized by a third-party risk assessment value generator from a third-party risk assessment system that can re-evaluate a risk assessment value of the user account. Indeed, the disclosed systems can provide for display, within a graphical user interface of an application, a selectable element to initiate an integration of the user account with the third-party risk assessment system to access functionalities that can improve a risk assessment value for the user account. In addition to the selectable element, the disclosed systems can also provide for display the determined recognized user activities from the user account that are potentially recognized (or utilized) by the third-party risk assessment value generator.

Upon receiving a selection to initiate the integration, the disclosed systems can integrate the user account with the third-party risk assessment system within the same application and provide user activities from the user account to the third-party risk assessment system for analysis within the third-party risk assessment value generator. In addition, the disclosed systems can receive a user risk assessment value from the third-party risk assessment system for display within the same application.

### BRIEF DESCRIPTION OF THE DRAWINGS

The detailed description is described with reference to the accompanying drawings in which:

FIG. 1 illustrates a schematic diagram of an environment for implementing an inter-network facilitation system and a risk assessment integration system in accordance with one or more implementations.

FIG. 2 illustrates an overview of a risk assessment integration system integrating a third-party risk assessment system in accordance with one or more implementations.

FIG. 3 illustrates a risk assessment integration system determining recognized user activities in accordance with one or more implementations.

FIGS. 4A and 4B illustrate a risk assessment integration system displaying recognized user activities for utilization by a third-party risk assessment value generator in accordance with one or more implementations.

FIGS. 5A and 5B illustrate a risk assessment integration system integrating a user account of an inter-network facilitation system with an additional user account on a third-party risk assessment system in accordance with one or more implementations.

FIGS. 6A and 6B illustrate a risk assessment integration system interfacing data and functionalities of a third-party risk assessment system in accordance with one or more implementations.

FIG. 7 illustrates a risk assessment integration system receiving a user risk assessment value and displaying the user risk assessment value within an application of an inter-network facilitation system in accordance with one or more implementations.

FIG. 8 illustrates a risk assessment integration system enabling a recognized user activity to be utilized by a risk assessment system in accordance with one or more implementations.

FIG. 9 illustrates a flowchart of a series of acts for determining and displaying recognized user activities for an integrated risk assessment value generator from a third-party system for risk assessment values in accordance with one or more implementations.

FIG. 10 illustrates a block diagram of an exemplary computing device in accordance with one or more implementations.

FIG. 11 illustrates an example environment for an inter-network facilitation system in accordance with one or more implementations.

### DETAILED DESCRIPTION

The disclosure describes one or more embodiments of a risk assessment integration system that determines and displays recognized user activities for an integrated risk assessment value generator from a third-party system utilized to improve a risk assessment value of a user account. For instance, the risk assessment integration system generates graphical user interfaces to efficiently and flexibly provide a user account access to user risk assessment data and functions to improve user risk assessment values from a third-party risk assessment system within a singular application of the risk assessment integration system. Indeed, the risk assessment integration system can determine user activities of the user account that are predicted to be recognized by the third-party risk assessment system. Furthermore, the risk assessment integration system can surface the recognized user activities with options to integrate with the third-party risk assessment system to improve a risk assessment value of a user account. Upon initiating the integration process, the risk assessment integration system can integrate the user account with an additional user account of the third-party risk assessment system within a singular application and provide user activity data to the third-party risk assessment system to generate a user risk assessment value for the user account (e.g., without leaving the application of the risk assessment integration system).

To illustrate, in one or more embodiments, the risk assessment integration system determines recognized user activities for an integrated risk assessment value generator from a third-party risk assessment system. In particular, prior to integrating user activities of a specific user account with the third-party risk assessment system, the risk assessment integration system can analyze user activities to detect user activities predicted to be recognized by the third-party risk assessment value generator (that operates as a black box mechanism) from the third-party risk assessment system. In one or more embodiments, the risk assessment integration system can display the recognized user activities for the user account, within a graphical user interface of an application, with a selectable option to integrate with the third-party risk assessment system to improve a risk assessment value of a user account.

Upon receiving a user interaction to integrate with the third-party risk assessment system, the risk assessment integration system can provide access to the third-party risk assessment system within the same application. For instance, the risk assessment integration system can integrate the user account within the application with an additional user account from the third-party risk assessment system. In particular, the risk assessment integration system can display, within a graphical user interface of the same application, enrollment user interfaces from the third-party risk assessment system to create or log into a user account on the third-party risk assessment system, identification verification user interfaces, and functionalities to improve a risk assessment value of the user on the third-party risk assessment system.

Upon integrating the user account with the third-party risk assessment system, the risk assessment integration system can utilize a secured data transmission protocol to transmit user activities from the user account to the third-party risk assessment system. Moreover, the third-party risk assessment system can utilize a risk assessment value generator with the received user activities to determine a user risk assessment value (and a change in the user risk assessment value to display the user risk assessment value within the application of the risk assessment integration system.

The risk assessment integration system can provide numerous advantages, benefits, and practical applications relative to conventional systems. To illustrate, in contrast to conventional systems that often require an inefficient number of navigational steps to access and display digital information and functionalities of a third-party system, the risk assessment integration system utilizes back end processes to securely integrate functionalities of a third-party risk assessment system within an application corresponding to the risk assessment integration system (or an inter-network facilitation system overall). For instance, the risk assessment integration system can integrate a user account from the inter-network facilitation system with a user account from the third-party risk assessment system within the application of the inter-network facilitation system to enable transmission of user activities to receive (and display) risk assessment values generated on the third-party risk assessment system. Indeed, this results in a practical application that efficiently reduces the number of navigational steps required to utilize functions of an inter-network facilitation system application while also accessing digital information and the functionalities of the third-party system within the same application.

Additionally, the risk assessment integration system also generates flexible and easy to use GUIs that provide rich and insightful data within limited screen spaces of mobile devices. For example, the risk assessment integration system, prior to integration, can utilize a user activity recognition model to identify user activities of a user account that may be recognized (or affect) a third-party risk assessment value generator that acts as a black box mechanism. Indeed, utilizing the recognized user activities, the risk assessment integration system can provide selectable options to utilize the third-party risk assessment system to improve a risk assessment value of the user account with insightful detail (e.g., detail that is viewable within a small screen) that outlines whether the user account includes activities that may be recognized by the third-party risk assessment value generator.

Furthermore, the risk assessment integration system, unlike many conventional systems, can accurately identify user activities of a user account that affect the black box mechanisms of computer-based models of third-party risk assessment systems. By doing so, the risk assessment integration system can accurately (and efficiently) identify user accounts that may benefit from utilizing computing resources to integrate with the third-party risk assessment system. Moreover, upon accurately pinpointing these relationships between user activity data of a user account and a third-party risk assessment value generator, the risk assessment integration system can provide functionalities (e.g., changing payment methods, auto configuring payment methods for transactions) to assist a user account with integration of the third-party risk assessment value generator.

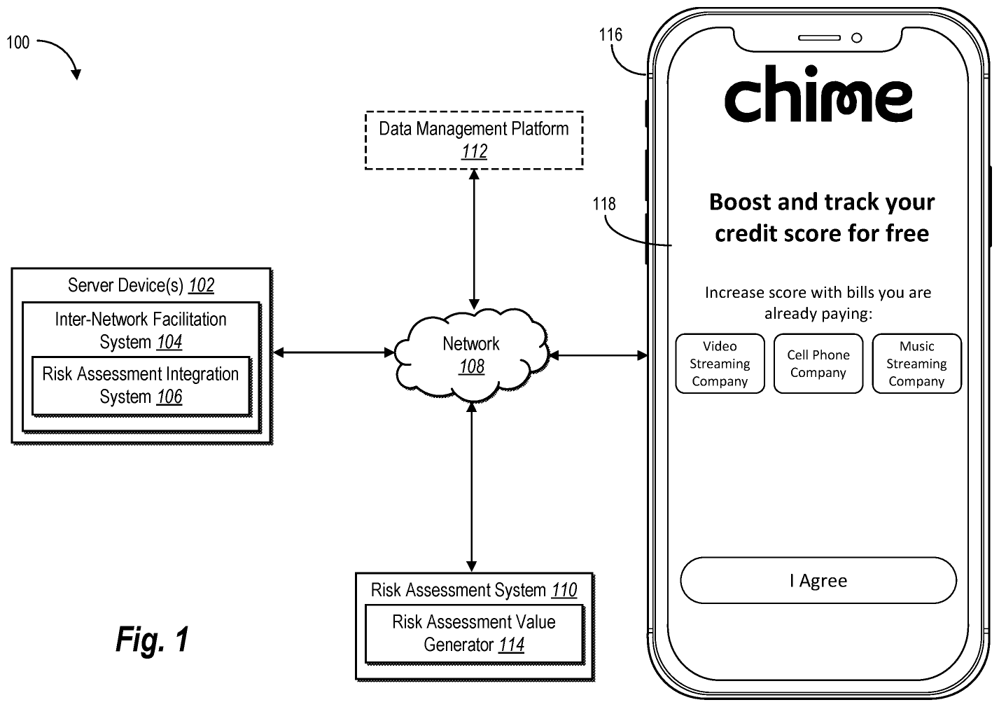

As indicated by the foregoing discussion, the present disclosure utilizes a variety of terms to describe features and advantages of the risk assessment integration system. As used herein, the term “user activity” refers to information (or data) associated with interactions of a user with a client application and/or an inter-network facilitation system (e.g., through a client application as shown in FIG. 1). For instance, user activity can include user actions corresponding to a user account, account values, and/or other representations of interactions of a user corresponding to the user account. To illustrate, a user activity can include, but is not limited to, a user account transaction. Indeed, a user account transaction can include an electronic communication or data log item that indicates at least one of an account number, a transaction amount, and/or a transaction facilitator for a transaction (e.g., an online purchase, an online payment, a deposit, a reoccurring subscription payment). In some cases, the user account transaction can include information for a payment method (e.g., a credit card, a bank account, a digital wallet).

Furthermore, as used herein, the term “recognized user activity” refers to a user activity that is (or is predicted to be) recognized by a computer-based model. In particular, the term “recognized user activity” can refer to an activity that is (or is predicted to be) utilized by a risk assessment value generator as input to determine an output risk assessment value. For example, in some embodiments, a recognized user activity includes recognized user account transactions that are (or are predicted to be) utilized (or recognized) by a risk assessment value generator (e.g., affect an output of the risk assessment value generator).

As used herein, the term “risk assessment value” refers to a metric that indicates a risk level corresponding to a user account (or a person associated with the user account). In particular, the term “risk assessment value” can refer to a metric (e.g., a value or score) that indicates likelihood of a person failing to pay off a credit value amount (e.g., a credit line or loan) utilized by the person. In one or more embodiments, a risk assessment value can include a credit score utilized by a credit scoring agency.

Turning now to the figures, FIG. 1 illustrates a block diagram of a system 100 (or system environment) for implementing an inter-network facilitation system 104 and a risk assessment integration system 106 in accordance with one or more embodiments. As shown in FIG. 1, the system 100 includes server device(s) 102 (which includes the inter-network facilitation system 104 and the risk assessment integration system 106), a risk assessment system 110, a data management platform 112, and a client device 116. As further illustrated in FIG. 1, the server device(s) 102, risk assessment system 110, data management platform 112, and client device 116 can communicate via the network 108.

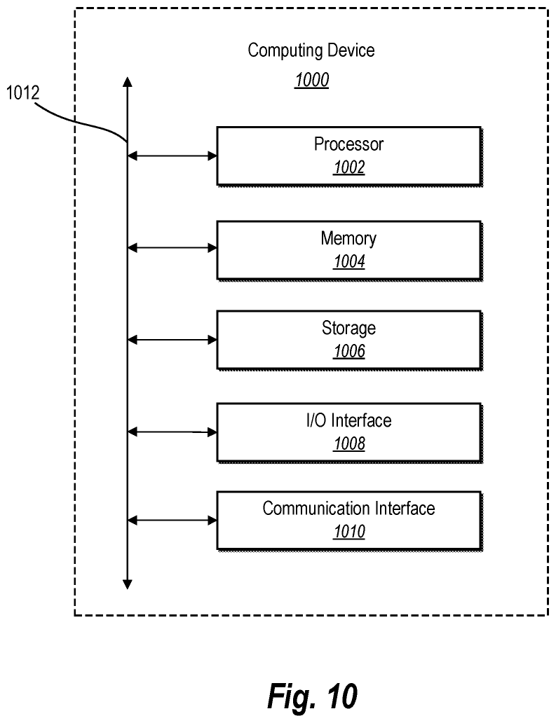

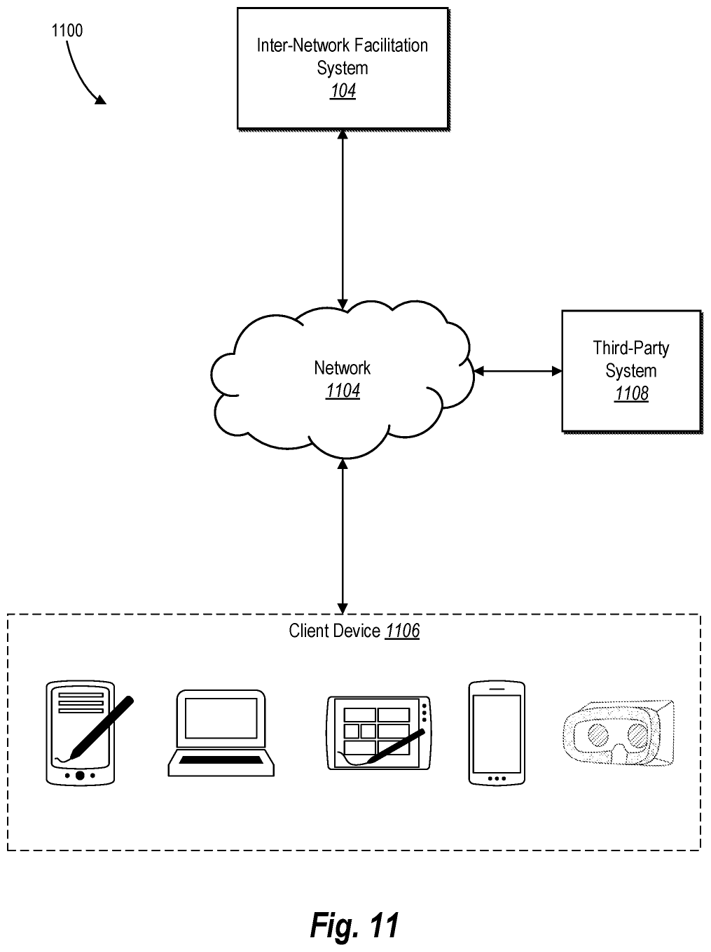

Although FIG. 1 illustrates the risk assessment integration system 106 being implemented by a particular component and/or device within the system 100, the risk assessment integration system 106 can be implemented, in whole or in part, by other computing devices and/or components in the system 100 (e.g., the client device 116). Additional description regarding the illustrated computing devices (e.g., the server device(s) 102, computing devices implementing the risk assessment system 110, the data management platform 112, the client device 116, and/or the network 108) is provided with respect to FIGS. 10 and 11 below.

The inter-network facilitation system 104 can include a system that comprises the risk assessment integration system 106 and that facilitates financial transactions and digital communications across different computing systems over one or more networks. For example, an inter-network facilitation system manages credit accounts, secured accounts, and other accounts for a single account registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

Additionally, the risk assessment integration system 106 can determine and display recognized user activities for an integrated risk assessment value generator from a third-party system utilized to improve a risk assessment value of a user account. As mentioned above, the risk assessment integration system 106 can determine user activities of the user account that are predicted to be recognized by the third-party risk assessment system. Then, the risk assessment integration system 106 can display the recognized user activities with selectable options to integrate with the third-party risk assessment system to improve a risk assessment value of a user account. Indeed, the risk assessment integration system 106 can integrate the user account with an additional user account of the third-party risk assessment system within a singular application and provide user activity data to the third-party risk assessment system to generate a user risk assessment value for the user account.

In one or more embodiments, the inter-network facilitation system 104 can implement the risk assessment integration system 106 as part of a credit building management system. In particular, the credit building management system can include one or more computer-based organizational, payment, and/or account configuration functions and/or tools to improve the risk assessment value (or credit value) corresponding to a user account. Indeed, the credit building management system can include a risk assessment value for a user account and functions to manage the risk assessment value. In some cases, the inter-network facilitation system 104 includes (as part of the credit building management system) the risk assessment integration system 106 to improve a risk assessment value for the user account via integration with a third-party risk assessment system (in accordance with one or more embodiments herein).

Additionally, as shown in FIG. 1, the system 100 can include the risk assessment system 110 (sometimes referred to as a third-party risk assessment system). For example, the risk assessment system 110 can include a third-party platform or system that manages and calculates a risk assessment value for a user account (or a person associated with the user account). For example, the risk assessment system 110 can include an entity that receives and analyzes user activity data from multiple sources to determine a risk assessment value (or credit worthiness) of a user account (or person associated with the user account). In some cases, the risk assessment system 110 can include a credit score bureau system that analyzes user activity data and determines credit scores for user accounts (or persons associated with the user accounts). As described in greater detail below, the risk assessment integration system 106 can transmit user activity data to the risk assessment system 110 and integrate functionalities of the risk assessment system 110 within a client application of the risk assessment integration system 106 (e.g., a client application 118).

As further shown in FIG. 1, the risk assessment system 110 includes a risk assessment value generator 114 (sometimes referred to as a third-party risk assessment value generator). For example, the risk assessment value generator 114 can include a computer-based model that utilizes input data to output a risk assessment value for a particular user account (or a person associated with the user account). In one or more embodiments, the risk assessment value generator 114 receives user account transactions and other user activity data (e.g., credit lines, payment information, payment history, transaction history) to output a risk assessment value for a person associated with the user account.

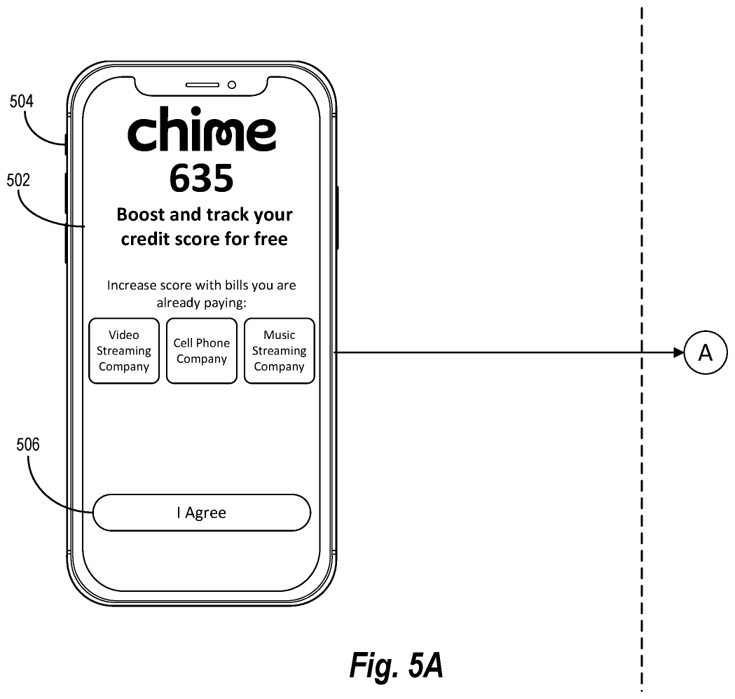

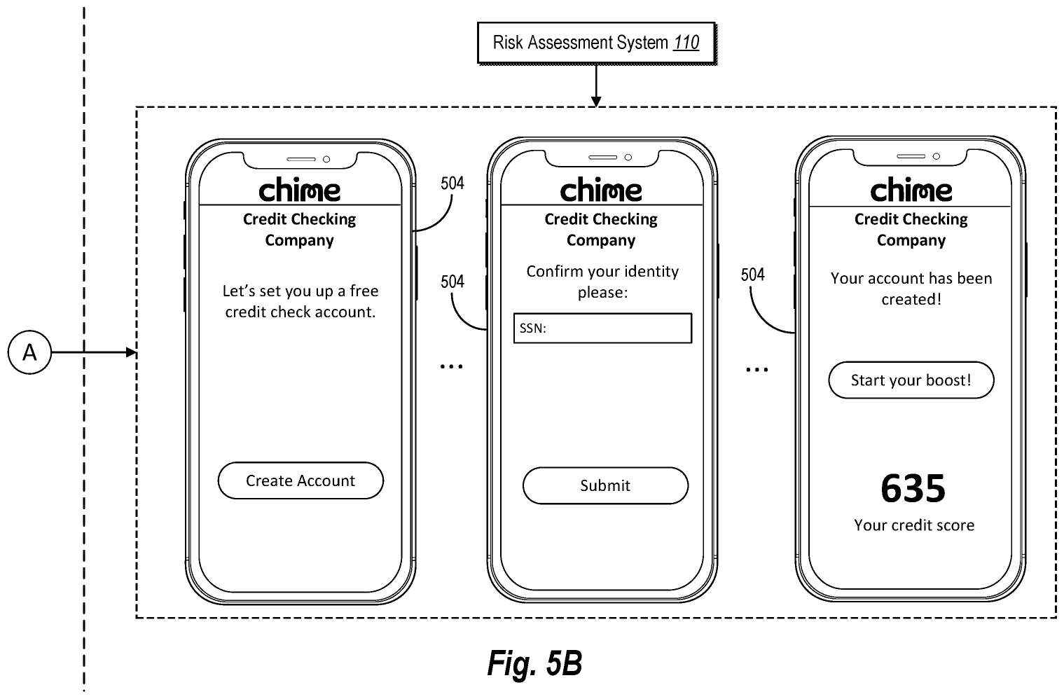

Additionally, as also shown in FIG. 1, the system 100 can include a data management platform 112. For example, the data management platform 112 can include a data manage platform that securely receives and transmits data between data storage structures of systems. In one or more embodiments, the data management platform 112 connects to the inter-network facilitation system 104 to retrieve user activity data and transmit the user activity data to the risk assessment system 110. In particular, the data management platform 112 can utilize an access delegation protocol to retrieve and transmit data between inter-network facilitation system 104 and the risk assessment system 110 as described below (e.g., in relation to FIGS. 5A and 5B).

As also illustrated in FIG. 1, the system 100 includes the client device 116. For example, the client device 116 may include, but are not limited to, mobile devices (e.g., smartphones, tablets) or other type of computing devices, including those explained below with reference to FIG. 10. Additionally, the client device 116 can include computing devices associated with (and/or operated by) user accounts for the inter-network facilitation system 104. Moreover, although FIG. 1 illustrates a single client device (e.g., client device 116), the system 100 can include various numbers of client devices that communicate and/or interact with the inter-network facilitation system 104 and/or the risk assessment integration system 106.

Furthermore, as shown in FIG. 1, the client device 116 include the client application 118. The client application 118 can include instructions that (upon execution) cause the client device 116 to perform various actions. For example, as shown in FIG. 1, a user of a user account can interact with the client application 118 on the client device 116 to access financial information, initiate a financial transaction (e.g., utilizing an account number), and/or select (or utilize) selectable options to initiate an integration of a risk assessment system and a risk assessment value (e.g., as displayed within the client application 118).

In certain instances, the client device 116 corresponds to a user account (e.g., a user account stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, risk assessment values, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of an inter-network facilitation system.

In addition, the client application 118 (via the client device 116) can provide user data activity (e.g., user account transactions) to the risk assessment integration system 106. In addition, the client application 118 can display recognized user activities and options to initiate an integration between the risk assessment integration system 106 and the risk assessment system 110 to utilize user activity data to improve a risk assessment value corresponding to the user account of the client application. Indeed, in one or more embodiments (as described below), the client application 118 can display and operate graphical user interfaces for the inter-network facilitation system 104 and the risk assessment system 110 while integrated by the risk assessment integration system 106.

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 10. Furthermore, although FIG. 1 illustrates the server device(s) 102, the risk assessment system 110, the data management platform 112, and the client device 116 communicating via the network 108, the various components of the system 100 can communicate and/or interact via other methods (e.g., the server device(s) 102 and the risk assessment system 110 can communicate directly).

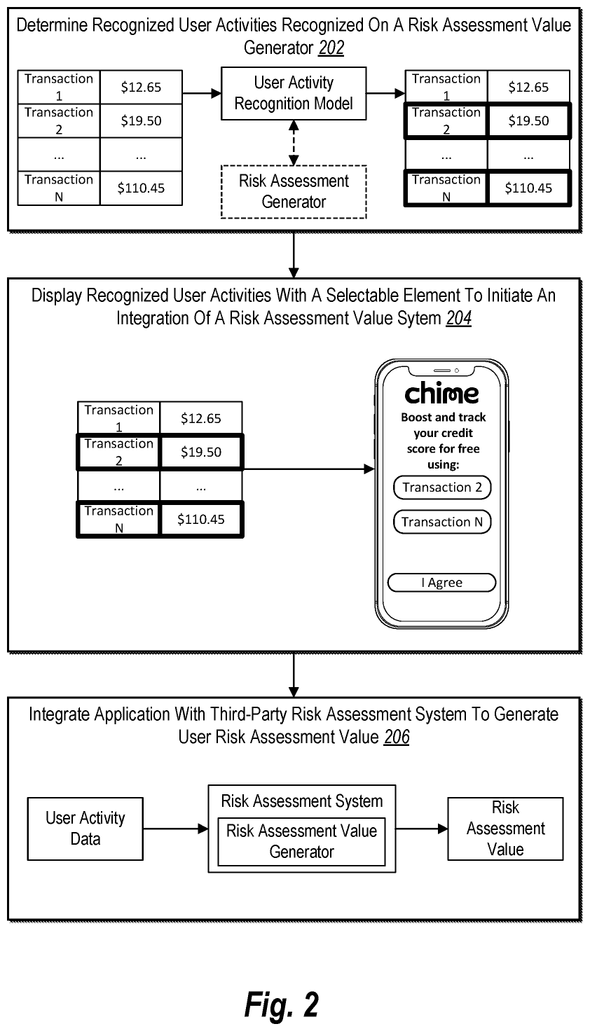

As mentioned above, the risk assessment integration system 106 can determine and display recognized user activities for an integrated risk assessment value generator from a third-party system utilized to improve a risk assessment value of a user account. For example, FIG. 2 illustrates an overview of the risk assessment integration system 106 integrating a third-party risk assessment system to determine and display recognized user activities to improve a risk assessment value of a user account. As shown in FIG. 2, the risk assessment integration system 106 can determine recognized user activities recognized on a risk assessment value generator, display the recognized user activities with a selectable element to initiate an integration of a risk assessment value, and integrate an application with a third-party risk assessment system to generate a user risk assessment value.

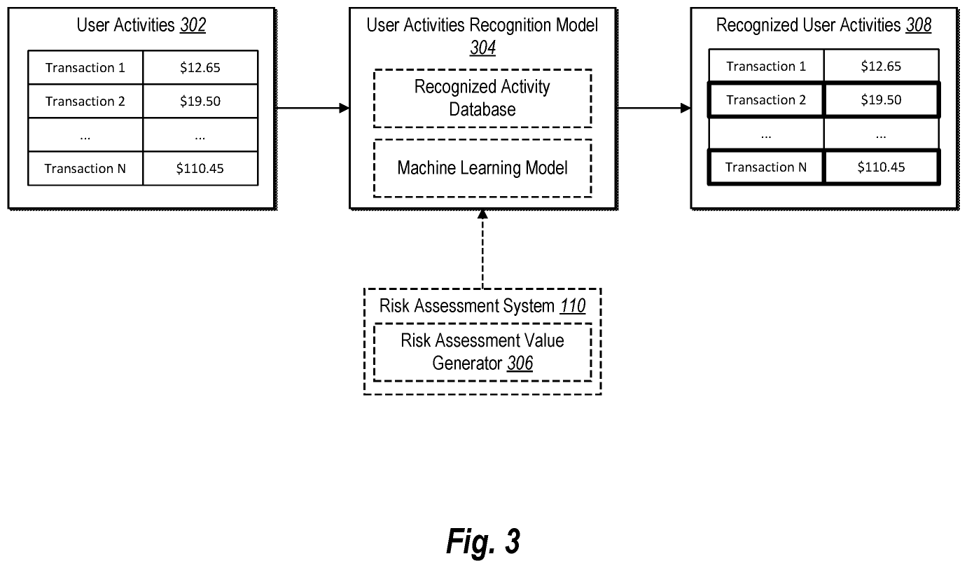

As shown in act 202 of FIG. 2, the risk assessment integration system 106 determines recognized user activities recognized on a risk assessment value generator. In particular, as shown in act 202 of FIG. 2, the risk assessment integration system 106 analyzes user activity data (e.g., transactions) with a user activity recognition model to identify user activities that is predicted to be recognized by a risk assessment generator (e.g., a third-party risk assessment generator). Additional detail regarding the risk assessment integration system 106 determining recognized user activities is described below (e.g., in relation to FIG. 3).

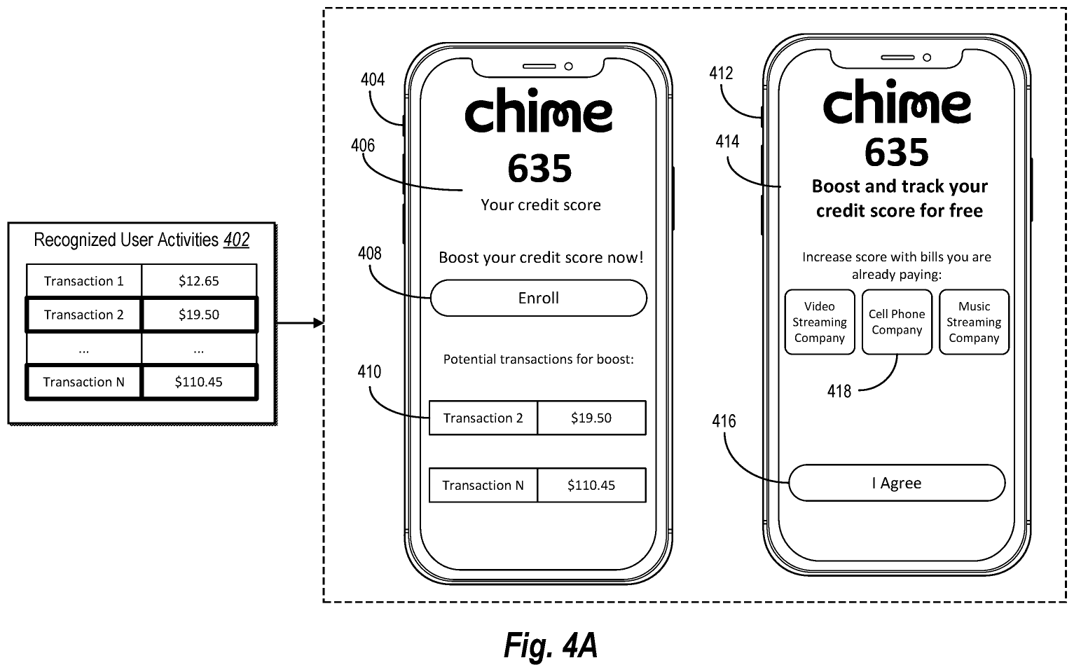

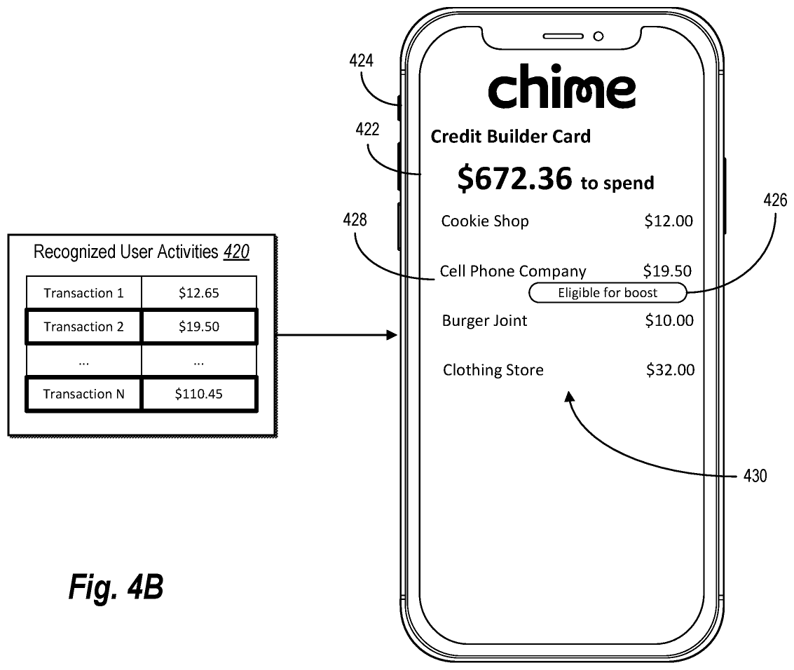

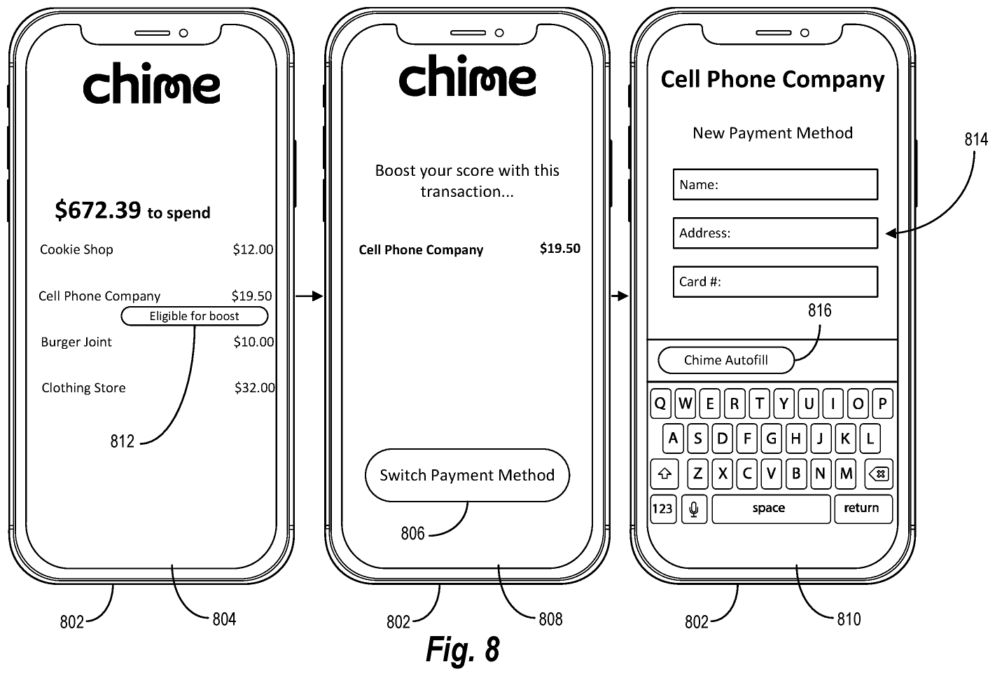

As further shown in act 204 of FIG. 2, the risk assessment integration system 106 displays recognized user activities with a selectable element to initiate an integration of a risk assessment value system. As illustrated in the act 204 of FIG. 2, the risk assessment integration system 106 displays the recognized user activities to indicate personalized user data that may be utilized to improve a risk assessment value of a user account from a third-party risk assessment system without having access to the computer-model based risk assessment value generator utilized on the third-party risk assessment system. In addition, as also shown in the act 204 of FIG. 2, the risk assessment integration system 106 also displays a selectable option to initiate an integration with the risk assessment value system to improve the risk assessment value of the user account. Additional detail regarding the risk assessment integration system 106 displaying recognized user activities and options to initiate an integration with a third-party risk assessment system is described below (e.g., in relation to FIGS. 4A, 4B, and 8).

Additionally, as illustrated in act 206 of FIG. 2, the risk assessment integration system 106 integrates an application (of the risk assessment integration system 106 or inter-network facilitation system 104) with a third-party risk assessment system to generate a user risk assessment value. In particular, upon receiving a user interaction to initiate an integration with a third-party risk assessment system, the risk assessment integration system 106 establishes communications with the third-party risk assessment system to transmit user activity data of the particular user account to the risk assessment system. The risk assessment system can utilize the user activity data with a risk assessment value generator to generate a risk assessment value for the user account. Indeed, in one or more embodiments, the risk assessment system is integrated into the application of the risk assessment integration system 106 or inter-network facilitation system 104 such that creating a user account, initiating the risk assessment value generator, and/or receiving the risk assessment value is integrated within the application. Additional detail regarding the integration of the third-party risk assessment system and generating a risk assessment value (or improved risk assessment value) within a singular application of the inter-network facilitation system is described below (e.g., in relation to FIGS. 5A, 5B, 6A, 6B, and 7).

As mentioned above, the risk assessment integration system 106 can determine recognized user activities, from user activities, for an integrated risk assessment value generator from a third-party risk assessment system. For example, FIG. 3 illustrates the risk assessment integration system 106 determining recognized user activities. Indeed, FIG. 3 illustrates the risk assessment integration system 106 determining recognized user activities that are determined to be relevant to a third-party risk assessment value generator (e.g., when the third-party risk assessment value generator acts as a black box mechanism to the risk assessment integration system 106).

As shown in FIG. 3, the risk assessment integration system 106 identifies user activities 302 for a user account of the inter-network facilitation system 104. As shown in FIG. 3, the user activities 302 include transactions of the user account. Indeed, in one or more embodiments, the user activities 302 include payment transactions that are managed (or cleared) by the inter-network facilitation system 104 and displayed within an application (e.g., client application 118) of the inter-network facilitation system 104 under the particular user account.

Then, as illustrated in FIG. 3, the risk assessment integration system 106 utilizes a user activities recognition model 304 that determines relationships between the user activities 302 and a risk assessment value generator 306 of a risk assessment system 110 (e.g., without accessing the risk assessment value generator 306). Indeed, the risk assessment integration system 106 utilizes the user activities recognition model 304 by comparing the user activities 302 to a recognized activity database or by inputting the user activities 302 within a machine learning model to identify user activities that are (or are predicted to be) recognized by the risk assessment value generator 306. As shown in FIG. 3, the risk assessment integration system 106 utilizes the user activities recognition model 304 with the user activities 302 to determine recognized user activities 308 (e.g., the highlighted user activities).

In one or more embodiments, the risk assessment integration system 106 utilizes the user activities recognition model to compare user activities to a recognized activity database. In particular, the risk assessment integration system 106 can receive a database of recognized activities (e.g., exemplary recognized user activities) from the third-party risk assessment system 110 (or an administrator device of the inter-network facilitation system 104). Moreover, the risk assessment integration system 106 can reference the recognized activity database to check whether a user activity is a recognized user activity. In some cases, the risk assessment integration system 106 determines a recognized user activity when a user activity matches an entry within the recognized activity database. In one or more embodiments, the risk assessment integration system 106 determines a recognized user activity when a user activity is similar to one or more recognized activities within the recognized activity database (e.g., via a clustering analysis, Euclidean distance analysis).

In certain instances, the risk assessment integration system 106 utilizes a machine learning model to determine recognized user activities. For example, the risk assessment integration system 106 can utilize a machine learning model that is trained to identify user activities that will likely be utilized by a third-party risk assessment generator. In some cases, the machine learning model is trained utilizing ground truth user activities that are known to be recognized (or not recognized) by a third-party risk assessment generator via backpropagation of losses from predictions (or classifications) made by the machine learning model for the ground truth user activities. For example, a machine learning model can include, but is not limited to, a neural network (e.g., a convolutional neural network, a recurrent neural network), a linear regression model, nearest neighbor model, and/or a decision tree model.

In some cases, the risk assessment integration system 106 utilizes historical user activity data from the inter-network facilitation system 104 to determine recognized user activities. For instance, the risk assessment integration system 106 can update a recognized activity database with user activity data that is indicated as used by the third-party risk assessment generator during integration. For example, in some cases, the third-party risk assessment system indicates user activities that will be input into the third-party risk assessment generator (upon scanning user activities to generate improvements for a risk assessment value as described below). The risk assessment integration system 106 can log these indicated user activities to determine recognized user activities for subsequent user activities.

In some embodiments, the risk assessment integration system 106 determines a number of recognized user activities required for the third-party risk assessment generator. For example, the risk assessment integration system 106 can identify (e.g., via administrator configuration and/or historical data) that a third-party risk assessment generator requires a threshold number of similar user activities to be recognized user activities (e.g., 3 reoccurring transactions, 4 reoccurring transactions). Then, the risk assessment integration system 106 can determine recognized user activities and determine whether the number of recognized user activities satisfies the threshold number of similar user activities (e.g., to decide whether to display the user activities).

As mentioned above, the risk assessment integration system 106 can display recognized user activities with a selectable option to integrate with a third-party risk assessment system to generate a potentially improved user risk assessment value for a user account. For example, FIGS. 4A and 4B illustrate the risk assessment integration system 106 surfacing recognized user activities prior to enrollment and utilization of the third-party risk assessment system. Indeed, FIGS. 4A and 4B illustrate the risk assessment integration system 106 providing a preview of possible improvements to a risk assessment value through the use of user activities identified to be (or likely to be) recognized by a third-party risk assessment value generator.

For example, as shown in FIG. 4A, the risk assessment integration system 106 utilizes recognized user activities 402 to generate a graphical user interface for integration with a risk assessment system. In particular, as shown in FIG. 4A, the risk assessment integration system 106 provides, within a graphical user interface 404 of client device 406, a selectable element 408 to initiate an integration with a third-party assessment system (e.g., an enroll button) with a list of recognized user activities 410 from the user account.

As further shown in FIG. 4A, the risk assessment integration system 106 can also provide, within a graphical user interface 414 of client device 412, a selectable element 416 to initiate an integration with a third-party assessment system (e.g., an “I Agree” button) with a list of recognized user activities 418 (e.g., as recognized entities) from the user account. For instance, the risk assessment integration system 106 can identify recognized user activities and determine a grouping (or common entity) for the recognized user activities. As an example, upon identifying that one or more recognized user activities correspond to a common entity or transaction facilitator (e.g., a particular payee, a company), the risk assessment integration system 106 can group the recognized user activity (or activities) using the identified common entity. For instance, as shown in FIG. 4A, the recognized user activities 418 (as recognized entities) display transactions with a video streaming company, a cell phone company, and a music streaming company on the user account are (or are likely to) be utilized by a risk assessment value generator. Although one or more embodiments describe specific recognized user entities (or transactions), the risk assessment integration system 106 can recognize various types of recognized user activities and/or entities.

Additionally, in some instances, the risk assessment integration system 106 can provide, for display within a graphical user interface having a list of user activities, recognized activity indicators adjacent to one or more user activities in the list of user activities for user activities determined as recognized on the risk assessment value generator of the third-party risk assessment system. For example, FIG. 4B illustrates the risk assessment integration system 106 displaying a recognized activity indicator adjacent to a recognized user activity. As shown in FIG. 4B, the risk assessment integration system 106 utilizes the recognized user activities 420 to display recognized activity indicators. For instance, as shown in FIG. 4B, the risk assessment integration system 106, within a graphical user interface 422 of a client device 424, displays a recognized activity indicator 426 adjacent to a recognized user activity 428 (in a displayed list of user activities 430 corresponding to a user account of the client device 424).

In some cases, the recognized activity indicator 426 can be a selectable graphical element. Indeed, the risk assessment integration system 106 can receive a user interaction selecting the recognized activity indicator 426. Upon receiving a user interaction, the risk assessment integration system 106 can navigate to a graphical user interface to initiate an integration with a third-party risk assessment system to improve a user risk assessment value (e.g., as described in one or more embodiments herein).

As mentioned above, the risk assessment integration system 106 can integrate with a third-party risk assessment system via a singular application of the inter-network facilitation system 104. For example, FIGS. 5A and 5B illustrate the risk assessment integration system 106 integrating a user account of the inter-network facilitation system 104 with an additional user account on the third-party risk assessment system. Indeed, FIGS. 5A and 5B illustrate the risk assessment integration system 106 integrating the risk assessment system to utilize functionalities (and access information) of the third-party risk assessment system within a singular application.

For example, as shown in FIG. 5A, the risk assessment integration system 106 provides for display, within a graphical user interface 502 of a client device 504, a selectable element 506 to initiate an integration with a third-party risk assessment system to improve a user risk assessment value. As shown in the transition from FIG. 5A to FIG. 5B, upon receiving a selection of the selectable element 506, the risk assessment integration system 106 can navigate to graphical user interfaces controlled by the risk assessment system 110 but displayed within the same application of the client device 504. As illustrated in FIG. 5B, the risk assessment integration system 106 can display one or more graphical user interfaces within the client device 504 for functionalities of the risk assessment system 110 to integrate a user account from the risk assessment system 110 with the user account of the inter-network facilitation system 104.

For instance, as shown in FIG. 5B, the risk assessment integration system 106 provides for display, within a graphical user interface of the client device 504, integration options from the risk assessment system 110. In particular, as illustrated in FIG. 5B, the risk assessment integration system 106 can display functions from the risk assessment system 110 to create an account with the risk assessment system 110 (e.g., a credit checking company) and/or verify a user identity with the risk assessment system 110 (within the same application). As further shown in FIG. 5B, the risk assessment integration system 106 can display functions and information from the risk assessment system 110 (within the same application) for a risk assessment value of the user (corresponding to the user account). Indeed, as shown in FIG. 5B, the risk assessment integration system 106 can display graphical user interfaces to manage a user risk assessment value of a user from the risk assessment system 110 within the application of the inter-network facilitation system 104 (e.g., the Chime mobile application).

In some cases, the risk assessment integration system 106 can display enrollment graphical user interfaces of the risk assessment system 110 within the application to create, merge, or log into an account of the risk assessment system 110. In some instances, the risk assessment integration system 106 enables the risk assessment system 110 to collect account information (e.g., email, password, phone number, name) to create an account on the risk assessment system 110. In one or more embodiments, the risk assessment integration system 106 can provide an option to utilize user account information for the user account of the inter-network facilitation system 104 to create an account on the risk assessment system 110 (e.g., utilize user account data to login, export user account information). Additionally, in one or more embodiments, the risk assessment integration system 106 can provide an option to log into the risk assessment system 110 (for existing users) within the application. In some cases, the risk assessment integration system 106 also provides functionality to reset passwords, change emails, and/or other user account configurations for the risk assessment system 110 within the application of the inter-network facilitation system 104 during integration.

In certain embodiments, the risk assessment integration system 106 can display verification graphical user interfaces of the risk assessment system 110 within the application to verify user identity. In some cases, the risk assessment system 110 (via the application of the risk assessment integration system 106) can receive verification information such as addresses, billing information (e.g., credit card numbers, bank account numbers), and/or personal identification information (e.g., social security number, license number). In addition, in one or more embodiments, the risk assessment integration system 106 can display verification graphical user interfaces of the risk assessment system 110 that present verification questions that verify identity (e.g., historical residences, historical property, historical bank account information).

Upon establishing an account and/or verification, the risk assessment integration system 106 can display user risk assessment value management graphical user interfaces of the risk assessment system 110 within the application. In particular, the risk assessment integration system 106 can enable a user to interact with various functions of the risk assessment system 110 to manage and/or access a user risk assessment value. For example, the risk assessment integration system 106 can enable the display of the user risk assessment value, initiate a risk assessment value reevaluation (using user activities) (e.g., to boost a credit score), and/or retrieve reports for the user risk assessment value.

In one or more embodiments, the risk assessment integration system 106 utilizes an application programming interface (API) to retrieve information and functionalities from the risk assessment system 110 for display within the application of the inter-network facilitation system 104. In some cases, the risk assessment integration system 106 sends interactions and receives responses from the risk assessment system 110 via the API. In one or more embodiments, the risk assessment integration system 106 generates a web view within the application to provide the digital information and functionalities (described herein) of the risk assessment system 110 without leaving the application.

Upon configuring a user account, logging in, and/or agreeing to terms of condition within the risk assessment system 110 portion of the application hosted by the risk assessment integration system 106, the risk assessment integration system 106 can provides options to select user accounts of the inter-network facilitation system 104 to connect (or integrate) with the risk assessment system 110. In some instances, the risk assessment integration system 106 automatically links eligible user accounts of the user to connect with the risk assessment integration system 106 upon access authorization. Indeed, in one or more embodiments, the risk assessment integration system 106 can enable user activity data from the linked user accounts to be utilized by the third-party risk assessment system to generate or improve a user risk assessment value of the user.

In one or more embodiments, to link user accounts to the risk assessment system 110, the risk assessment integration system 106 can utilize internal unique identifiers between the risk assessment integration system 106 and the third-party risk assessment system 110. For instance, the risk assessment integration system 106 can generate a user identifier that references the same user account on the inter-network facilitation system 104 and the risk assessment system 110. For example, the unique user identifier can include a hash value or a 128-bit universally unique identifier (UUID).

Furthermore, in order to authenticate user account access between the inter-network facilitation system 104 and the third-party risk assessment system 110, the risk assessment integration system 106 can utilize an access delegation protocol. For instance, the risk assessment integration system 106 can utilize an access delegation protocol to share data of user accounts from the inter-network facilitation system 104 to the risk assessment system 110. Indeed, the risk assessment integration system 106 can utilize an access delegation protocol that securely enables the transmission of data of a user account to a connect user account from another system without exchanging passwords or access credentials across the multiple systems.

In some embodiments, the risk assessment integration system 106 utilizes an open authorization (OAUTH) protocol to exchange data between the inter-network facilitation system 104 and the third-party risk assessment system 110 (and/or the data management platform). In particular, the risk assessment integration system 106 can receive an authorization request from the third-party risk assessment system. Upon receiving user authorization via an authorization permission selection in an application of the inter-network facilitation system 104, the risk assessment integration system 106 provides an authorization grant (and in some cases an access token) to the third-party risk assessment system. Additionally, the third-party risk assessment system can utilize the authorization grant to obtain an access token that is utilized to request data from the risk assessment integration system 106. Indeed, the risk assessment integration system 106 can communicate with the third-party risk assessment system 110 utilizing an OAUTH protocol that includes access tokens, authorization grants, authorization codes, and/or refresh tokens.

For example, the third-party risk assessment system can utilize the access tokens to request (via a call) to add user accounts from the inter-network facilitation system 104. Furthermore, the risk assessment integration system 106 can verify the authentication code (or access tokens) and supply account details to the third-party risk assessment system. In some embodiments, the risk assessment integration system 106 communicates with a data platform management system having an access token (e.g., sometimes provided by the risk assessment system 110) to receive and transmit data from the inter-network facilitation system 104 to the third-party risk assessment system 110. In some instances, the authorization between the inter-network facilitation system 104 to the third-party risk assessment system 110 continues to exist upon a change of password (or extended periods of time) and is removable through deregistration (e.g., expiration, user cancellation) of the authorization between the risk assessment system 110 and the inter-network facilitation system 104.

In one or more embodiments, the risk assessment integration system 106 communicates with a data management platform to transmit data between the inter-network facilitation system 104 and the third-party risk assessment system 110. In some instances, the risk assessment integration system 106 provides an access token (e.g., a short-live token) to the risk assessment system 110 and the risk assessment system 110 provides the access token to the data management platform. Then, in some cases, the risk assessment integration system 106 can receive the access token (e.g., the short-live token) from the data management platform and, in turn, provide the data management platform with an additional access token (e.g., a long-live token). In one or more embodiments, the risk assessment integration system 106 provides the data management platform with user activity data upon receiving the additional access token. Indeed, the data management platform can receive user activity data from the risk assessment integration system 106 and provide the user activity data to the risk assessment system 110.

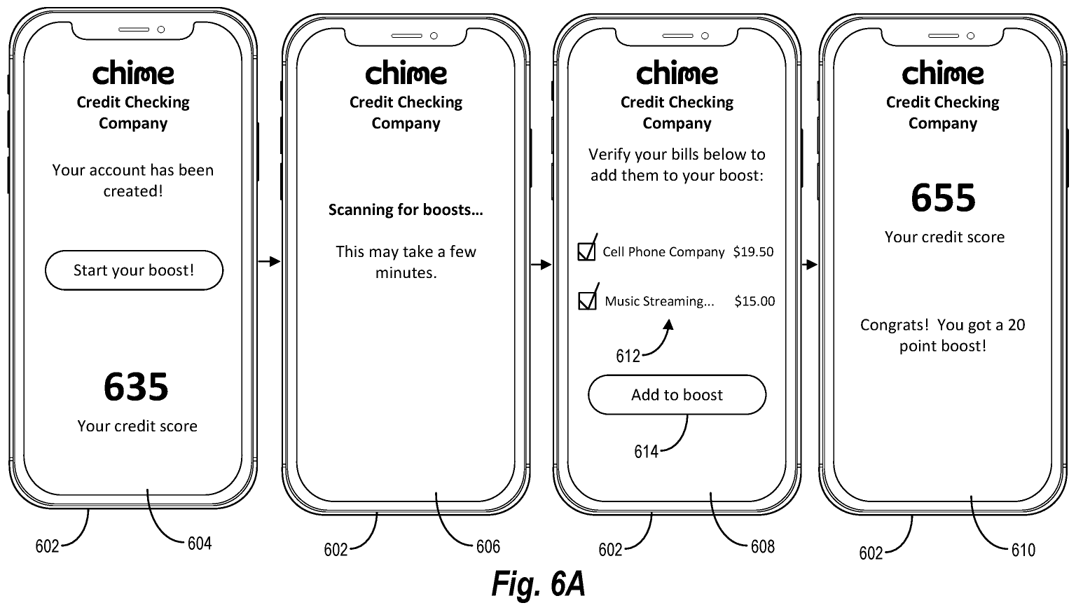

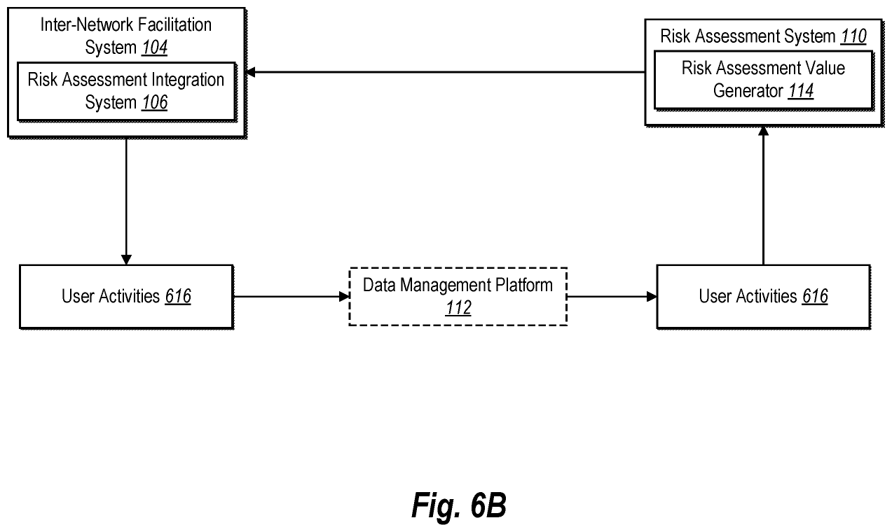

Upon integration and authentication, the risk assessment integration system 106 connects with the third-party system to provide user activity data to be utilized in a risk assessment value generation process. For example, FIGS. 6A and 6B illustrate the risk assessment integration system 106 providing, for display within graphical user interfaces controlled by the third-party risk assessment system, data for the utilization of user activity data to improve a user risk assessment value on the third-party risk assessment system 110. Indeed, the risk assessment integration system 106 can display and provide functions from the third-party risk assessment system 110 within an application of the inter-network facilitation system 104.

For instance, as shown in FIG. 6A, the risk assessment integration system 106 can provide, for display a graphical user interface 604 of the risk assessment system within a client device 602 operating an application of the inter-network facilitation system 104, that provides functionality to initiate a user activity data evaluation process to improve a user risk assessment value. Upon receiving a selection to initiate the process, the risk assessment integration system 106, as shown in FIG. 6A, displays a graphical user interface 606 from the risk assessment system that evaluates user activity data (of the user account from the inter-network facilitation system 104) for the risk assessment value generator. Then, as shown in FIG. 6A, the risk assessment integration system 106 displays a graphical user interface 608 from the risk assessment system that indicates user activities 612 identified by the risk assessment system (e.g., that can be selected or deselected) for the risk assessment value generator. Indeed, upon receiving a user interaction with a selectable element 614 to utilize the identified user activities to improve a risk assessment value, the risk assessment integration system 106 displays a graphical user interface 610 of the risk assessment system that presents a risk assessment value generated by the risk assessment system using the user activity data.

During the process illustrated in FIG. 6A, the risk assessment integration system 106 exchanges various data in the back end to enable to risk assessment system to utilize user activity data from the inter-network facilitation system 104. For example, FIG. 6B illustrates communications between the risk assessment integration system 106 and the risk assessment system 110 while utilizing user activity data to improve a risk assessment value within an application of the inter-network facilitation system 104. As shown in FIG. 6B, the risk assessment integration system 106 transmits user activities 616 to the data management platform 112 (e.g., via OAUTH as described above). Then, as shown in FIG. 6B, the data management platform 112 provides the user activities 616 to the risk assessment system 110. Then, FIG. 6B illustrates the risk assessment system 110 utilizing the user activities 616 with a risk assessment value generator 114 to generate a user risk assessment value for the user account of the inter-network facilitation system 104. Indeed, the risk assessment integration system 106 can receive the user risk assessment value from the risk assessment system 110.

In some embodiments, the third-party risk assessment system can utilize user activity data to modify an existing user risk assessment value by generating a new user risk assessment value from the risk assessment value generator. In some cases, the risk assessment system can generate a user risk assessment value that is an improvement over the existing user risk assessment value (e.g., increasing a credit score), no change in an existing user risk assessment value (e.g., no change in a credit score), or decrease over the existing user risk assessment value (e.g., decreasing a credit score). Furthermore, in one or more embodiments, the third-party risk assessment system (via the application of the inter-network facilitation system 104) can provide information describing the change in the user risk assessment value. Moreover, in some instances, the risk assessment integration system 106 can provide, via the risk assessment system, a selectable option to remove the utilization of the user activity data in the evaluation of the user risk assessment value.

Additionally, the risk assessment integration system 106 can generate graphical user interfaces from the risk assessment system to identify pending user activity data that can be utilized by the risk assessment value generator upon repeated occurrences. For example, the risk can generate a graphical user interface from the risk assessment system that indicates a user activity and a number of times the user activity has to occur to be recognized by the risk assessment value generator.

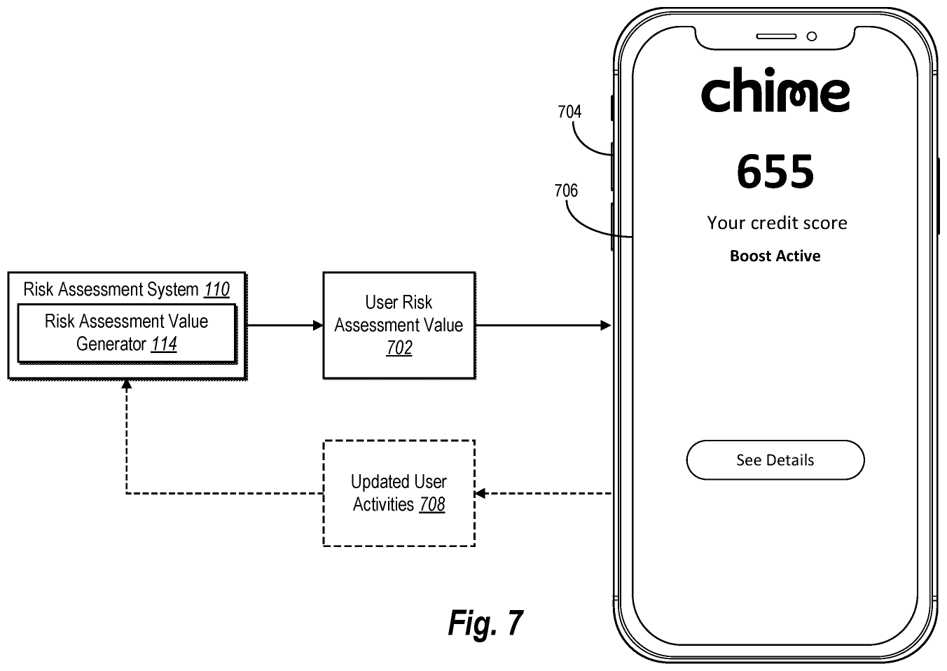

As mentioned above, the risk assessment integration system 106 can receive a user risk assessment value from the risk assessment system for a user account. For example, FIG. 7 illustrates the risk assessment integration system 106 receiving a user risk assessment value and displaying the user risk assessment value within the application of the inter-network facilitation system 104. As shown in FIG. 7, the risk assessment system 110 transmits a user risk assessment value 702 (from the risk assessment value generator 114) to the risk assessment integration system 106 which causes a client application 706 (of a client device 704) to display the user risk assessment value 702. In addition, the risk assessment integration system 106 can provide a selectable element (e.g., “See Details”) that upon selection navigates the client application 706 to graphical user interfaces controlled by the risk assessment system 110 to manage the user risk assessment value (as described above).

Furthermore, in some cases, the risk assessment integration system 106 can identify that the user account is enrolled to enable the risk assessment system to utilize user activity data in generating a user risk assessment value (e.g., in a credit score boost program). Based on the enrollment status of the user account with the risk assessment system, the risk assessment integration system 106 can provide updates to the risk assessment system to update a user risk assessment value.

For example, as shown in FIG. 7, the risk assessment integration system 106 can transmit updated user activities 708 to the risk assessment system 110. Then, the risk assessment system 110 can utilize the updated user activities 708 to generate changes in a user risk assessment value (using the risk assessment value generator 114). Subsequently, the risk assessment integration system 106 can receive the updated user risk assessment value (e.g., as the user risk assessment value 702) to display the updated user risk assessment value. Indeed, the risk assessment integration system 106 can send updated user activity data and receive changes to the user risk assessment value from the third-party risk assessment system without navigating to the third-party risk assessment system (when the user account is enrolled to enable the risk assessment system to utilize user activity data in generating a user risk assessment value).

As mentioned above, in some cases, the risk assessment integration system 106 can determine and display recognized user activity indicators adjacent to recognized user activities. In addition to indicating recognized user activities within a list of user activities, the risk assessment integration system 106 can provide functionalities to quickly and efficiently utilize the recognized user activity as part of the risk assessment system with a reduced number of steps. For instance, FIG. 8 illustrates the risk assessment integration system 106 enabling a user activity to be utilized by the risk assessment system. Indeed, FIG. 8 illustrates the risk assessment integration system 106, in response to identifying a particular user activity as a recognized user activity, providing, for display, an option to utilize user account information of the inter-network facilitation system 104 to complete the particular user activity within a third-party platform to utilize the particular user activity as the recognized user activity on the risk assessment value generator of the third-party risk assessment system.

As shown in FIG. 8, the risk assessment integration system 106 provides for display, within a graphical user interface 804 of a client device 802, a recognized user activity indicator 812. Upon receiving a selection of the recognized user activity indicator 812 (or the corresponding user activity), the risk assessment integration system 106 can provide, for display within a graphical user interface 808, information related to the selected user activity. In addition, as shown in FIG. 8, the risk assessment integration system 106 can provide a selectable option 806 to switch a payment method for the user activity (e.g., a transaction) such that the activity is recognized by the risk assessment value generator of the third-party risk assessment system.

Upon selection of the selectable option 806, the risk assessment integration system 106 provides for display, within a graphical user interface 810, options to change a payment method 814 for the particular user activity (e.g., within a third-party platform). In addition, the risk assessment integration system 106 also provides a shortcut option 816 to autofill the payment method information with a payment method from the inter-network facilitation system 104 that is recognized (or predicted to be recognized) by the risk assessment system. In some instances, the risk assessment integration system 106 can automatically pre-fill the payment method information to a payment method that is a recognized user activity for the third-party risk assessment system.

In some cases, the risk assessment integration system 106 can provide various functionalities for the recognized user activity. For example, the risk assessment integration system 106 can, for a recognized transaction, determine an average cost (from other user transactions) and notify the user account of a high cost transactions (e.g., a bill being higher than other user bills for a similar transaction). In some cases, the risk assessment integration system 106 can provide a selectable option to contact the transaction facilitator for the recognized transaction (that is a high cost transaction) to report or reduce the transaction value. In some cases, the risk assessment integration system 106 can provide selectable options for alternative transaction facilitators (e.g., merchants) for a recognized user activity.

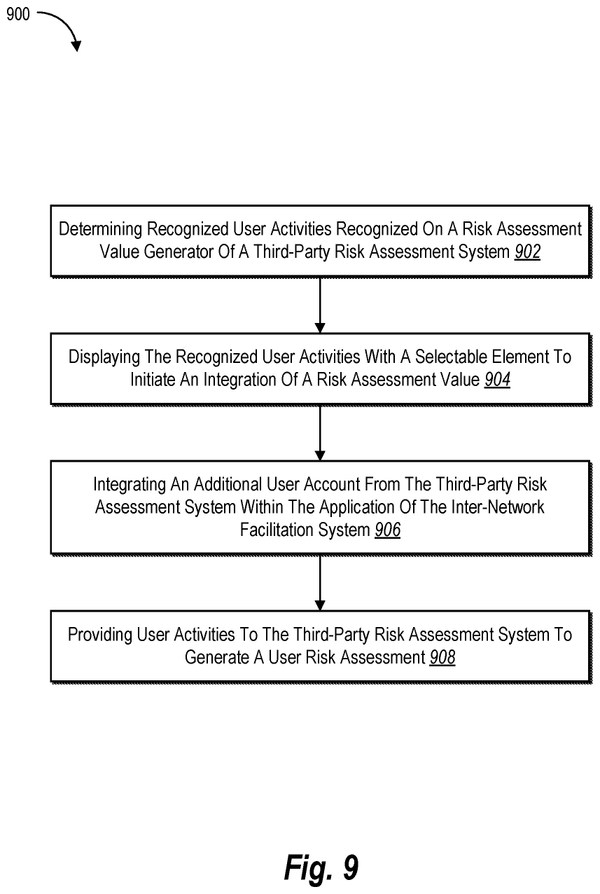

Turning now to FIG. 9, this figure shows a flowchart of a series of acts 900 for determining and displaying recognized user activities for an integrated risk assessment value generator from a third-party system for risk assessment values in accordance with one or more implementations. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable storage medium can comprise instructions that, when executed by the one or more processors, cause a computing device to perform the acts depicted in FIG. 9. In still further embodiments, a system can perform the acts of FIG. 9.

As shown in FIG. 9, the series of acts 900 include an act 902 of determining recognized user activities recognized on a risk assessment value generator of a third-party risk assessment system. In particular, the act 902 can include determining, from a set of user activities of a user account corresponding to an inter-network facilitation system, a set of recognized user activities recognized on a risk assessment value generator of a third-party risk assessment system. Furthermore, the act 902 can include utilizing a database of recognized user activities to determine a set of recognized user activities. In addition, the act 902 can include utilizing a machine learning model to determine a set of recognized user activities. In some instances, the act 902 includes determining a set of recognized entities from subsets of recognized user activities from a set of recognized user activities.

Furthermore, as also shown in FIG. 9, the series of acts 900 include an act 904 of displaying the recognized user activities with a selectable element to initiate an integration of a risk assessment value. For example, the act 904 can include providing, for display within a graphical user interface of an application of an inter-network facilitation system, a determined set of recognized activities with a selectable element to initiate an integration of a risk assessment value from a third-party risk assessment system with a user account of the inter-network facilitation system. In some cases, the act 904 can include providing, for display within a graphical user interface of an application of an inter-network facilitation system, a set of recognized entities with a selectable element to initiate an integration of a risk assessment value.

Additionally, the act 904 can include providing, for display within a graphical user interface comprising a list of user activities, one or more recognized activity indicators adjacent to one or more user activities in the list of user activities for user activities determined as recognized on a risk assessment value generator of a third-party risk assessment system. In addition, the act 904 can include identifying a particular user activity that is a recognized user activity and, in response to identifying the particular user activity, providing, for display, an option to utilize user account information of an inter-network facilitation system to complete the particular user activity within a third-party platform to utilize the particular user activity as a recognized user activity on the risk assessment value generator of a third-party risk assessment system.

As further shown in FIG. 9, the series of acts 900 include an act 906 of integrating an additional user account from the third-party risk assessment system within the application of the inter-network facilitation system. For example, the act 906 can include, upon receiving a user interaction with a selectable element to enroll, integrating, within an application of an inter-network facilitation system, an additional user account from a third-party risk assessment system with a user account corresponding to the inter-network facilitation system. In addition, the act 906 can include receiving a user interaction indicating permission to provide user activity data to a third-party risk assessment system and user login information to integrate an additional user account from the third-party risk assessment system with a user account corresponding to an inter-network facilitation system.

Moreover, as shown in FIG. 9, the series of acts 900 include an act 908 of providing user activities to the third-party risk assessment system to generate a user risk assessment. For instance, the act 908 can include providing a set of user activities to a third-party risk assessment system to generate a user risk assessment value for a user account based on a risk assessment value generator of the third-party risk assessment system. In addition, the act 908 can include providing, for display within a graphical user interface of an application of an inter-network facilitation system, a user risk assessment value from a risk assessment value generator of a third-party risk assessment system. Additionally, the act 908 can include providing updated user activities to a third-party risk assessment system, receiving an updated user risk assessment value from a risk assessment value generator of the third-party risk assessment system, and providing, for display within a graphical user interface of an application of an inter-network facilitation system, the updated user risk assessment value. In some cases, the act 908 can include, upon receiving a user interaction indicating a permission to provide user activity data, providing a set of user activities to a third-party risk assessment system via a third-party data management platform.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that the risk assessment integration system 106 (or the inter-network facilitation system 104) can comprise implementations of a computing device, including, but not limited to, the devices or systems illustrated in the previous figures. As shown by FIG. 10, the computing device can comprise a processor 1002, memory 1004, a storage device 1006, an I/O interface 1008, and a communication interface 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, storage device 1006 can comprise a non-transitory storage medium described above. The storage device 1006 may include a hard disk drive (“HDD”), flash memory, a Universal Serial Bus (“USB”) drive or a combination of these or other storage devices.

The computing device 1000 also includes one or more input or output (“I/O”) interface 1008, which are provided to allow a user (e.g., requester or provider) to provide input to (such as user strokes), receive output from, and otherwise transfer data to and from the computing device 1000. These I/O interface 1008 may include a mouse, keypad or a keyboard, a touch screen, camera, optical scanner, network interface, modem, other known I/O devices or a combination of such I/O interface 1008. The touch screen may be activated with a stylus or a finger.

The I/O interface 1008 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices 1000 or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include a bus 1012. The bus 1012 can comprise hardware, software, or both that couples components of computing device 1000 to each other.

FIG. 11 illustrates an example network environment 1100 of the inter-network facilitation system 104. The network environment 1100 includes a client device 1106 (e.g., client devices 112a-112n), an inter-network facilitation system 104, and a third-party system 1108 connected to each other by a network 1104. Although FIG. 11 illustrates a particular arrangement of the client device 1106, the inter-network facilitation system 104, the third-party system 1108, and the network 1104, this disclosure contemplates any suitable arrangement of client device 1106, the inter-network facilitation system 104, the third-party system 1108, and the network 1104. As an example, and not by way of limitation, two or more of client device 1106, the inter-network facilitation system 104, and the third-party system 1108 communicate directly, bypassing network 1104. As another example, two or more of client device 1106, the inter-network facilitation system 104, and the third-party system 1108 may be physically or logically co-located with each other in whole or in part.

Moreover, although FIG. 11 illustrates a particular number of client devices 1106, inter-network facilitation system 104, third-party systems 1108, and networks 1104, this disclosure contemplates any suitable number of client devices 1106, inter-network facilitation system 104, third-party systems 1108, and networks 1104. As an example, and not by way of limitation, network environment 1100 may include multiple client devices 1106, inter-network facilitation system 104, third-party systems 1108, and/or networks 1104.

This disclosure contemplates any suitable network 1104. As an example, and not by way of limitation, one or more portions of network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1104 may include one or more networks 1104.

Links may connect client device 1106, inter-network facilitation system 104 (e.g., which hosts the risk assessment integration system 106), and third-party system 1108 to network 1104 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, the client device 1106 may be an electronic device including hardware, software, or embedded logic components or a combination of two or more such components and capable of carrying out the appropriate functionalities implemented or supported by client device 1106. As an example, and not by way of limitation, a client device 1106 may include any of the computing devices discussed above in relation to FIG. 10. A client device 1106 may enable a network user at the client device 1106 to access network 1104. A client device 1106 may enable its user to communicate with other users at other client devices 1106.

In particular embodiments, the client device 1106 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1106 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1106 one or more Hyper Text Markup Language (“HTML”) files responsive to the HTTP request. The client device 1106 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-address sable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1104) to link the third-party-system 1108. For example, the inter-network facilitation system 104 may receive authentication credentials from a user to link a third-party system 1108 such as an online bank account, credit account, debit account, or other financial account to a user account within the inter-network facilitation system 104. The inter-network facilitation system 104 can subsequently communicate with the third-party system 1108 to detect or identify balances, transactions, withdrawal, transfers, deposits, credits, debits, or other transaction types associated with the third-party system 1108. The inter-network facilitation system 104 can further provide the aforementioned or other financial information associated with the third-party system 1108 for display via the client device 1106. In some cases, the inter-network facilitation system 104 links more than one third-party system 1108, receiving account information for accounts associated with each respective third-party system 1108 and performing operations or transactions between the different systems via authorized network connections.

In particular embodiments, the inter-network facilitation system 104 may interface between an online banking system and a credit processing system via the network 1104. For example, the inter-network facilitation system 104 can provide access to a bank account of a third-party system 1108 and linked to a user account within the inter-network facilitation system 104. Indeed, the inter-network facilitation system 104 can facilitate access to, and transactions to and from, the bank account of the third-party system 1108 via a client application of the inter-network facilitation system 104 on the client device 1106. The inter-network facilitation system 104 can also communicate with a credit processing system, an ATM system, and/or other financial systems (e.g., via the network 1104) to authorize and process credit charges to a credit account, perform ATM transactions, perform transfers (or other transactions) across accounts of different third-party systems 1108, and to present corresponding information via the client device 1106.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1108), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1100 either directly or via network 1104. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1106, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1104.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1106. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1106. Information may be pushed to a client device 1106 as notifications, or information may be pulled from client device 1106 responsive to a request received from client device 1106. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1106 associated with users.

In addition, the third-party system 1108 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1104. A third-party system 1108 can communicate with the inter-network facilitation system 104 to provide financial information pertaining to balances, transactions, and other information, whereupon the inter-network facilitation system 104 can provide corresponding information for display via the client device 1106. In particular embodiments, a third-party system 1108 communicates with the inter-network facilitation system 104 to update account balances, transaction histories, credit usage, and other internal information of the inter-network facilitation system 104 and/or the third-party system 1108 based on user interaction with the inter-network facilitation system 104 (e.g., via the client device 1106). Indeed, the inter-network facilitation system 104 can synchronize information across one or more third-party systems 1108 to reflect accurate account information (e.g., balances, transactions, etc.) across one or more networked systems, including instances where a transaction (e.g., a transfer) from one third-party system 1108 affects another third-party system 1108.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, from a set of user activities of a user account corresponding to an inter-network facilitation system, a set of recognized user activities recognized on a risk assessment value generator of a third-party risk assessment system;
providing, for display within a graphical user interface of an application of the inter-network facilitation system, the determined set of recognized activities with a selectable element to initiate an integration of a risk assessment value from the third-party risk assessment system with the user account of the inter-network facilitation system;
upon receiving a user interaction with the selectable element to enroll, integrating, within the application of the inter-network facilitation system, an additional user account from the third-party risk assessment system with the user account corresponding to the inter-network facilitation system; and
providing the set of user activities to the third-party risk assessment system to generate a user risk assessment value for the user account based on the risk assessment value generator of the third-party risk assessment system.

2. The computer-implemented method of claim 1, further comprising utilizing a database of recognized user activities to determine the set of recognized user activities.

3. The computer-implemented method of claim 1, further comprising:
determining a set of recognized entities from subsets of recognized user activities from the set of recognized user activities; and
providing, for display within the graphical user interface of the application of the inter-network facilitation system, the set of recognized entities with the selectable element to initiate the integration of the risk assessment value.

4. The computer-implemented method of claim 1, further comprising providing, for display within a graphical user interface comprising a list of user activities, one or more recognized activity indicators adjacent to one or more user activities in the list of user activities for user activities determined as recognized on the risk assessment value generator of the third-party risk assessment system.

5. The computer-implemented method of claim 1, further comprising:
identifying a particular user activity that is a recognized user activity; and
in response to identifying the particular user activity, providing, for display, an option to utilize user account information of the inter-network facilitation system to complete the particular user activity within a third-party platform to utilize the particular user activity as the recognized user activity on the risk assessment value generator of the third-party risk assessment system.

6. The computer-implemented method of claim 1, further comprising providing, for display within the graphical user interface of the application of the inter-network facilitation system, the user risk assessment value from the risk assessment value generator of the third-party risk assessment system.

7. The computer-implemented method of claim 1, based on an enrollment status of the user account with the additional user account from the third-party risk assessment system, further comprising:
providing updated user activities to the third-party risk assessment system;
receiving an updated user risk assessment value from the risk assessment value generator of the third-party risk assessment system; and
providing, for display within the graphical user interface of the application of the inter-network facilitation system, the updated user risk assessment value.

8. The computer-implemented method of claim 1, further comprising receiving a user interaction indicating permission to provide user activity data to the third-party risk assessment system and user login information to integrate the additional user account from the third-party risk assessment system with the user account corresponding to the inter-network facilitation system.

9. The computer-implemented method of claim 8, further comprising, upon receiving the user interaction indicating the permission to provide the user activity data, providing the set of user activities to the third-party risk assessment system via a third-party data management platform.

10. A non-transitory computer-readable medium storing instructions that, when executed by at least one processor, cause a computing device to:
determine, from a set of user activities of a user account corresponding to an inter-network facilitation system, a set of recognized user activities recognized on a risk assessment value generator of a third-party risk assessment system;
provide, for display within a graphical user interface of an application of the inter-network facilitation system, the determined set of recognized activities with a selectable element to initiate an integration of a risk assessment value from the third-party risk assessment system with the user account of the inter-network facilitation system;
upon receiving a user interaction with the selectable element to enroll, integrate, within the application of the inter-network facilitation system, an additional user account from the third-party risk assessment system with the user account corresponding to the inter-network facilitation system; and
provide the set of user activities to the third-party risk assessment system to generate a user risk assessment value for the user account based on the risk assessment value generator of the third-party risk assessment system.

11. The non-transitory computer-readable medium of claim 10, further comprising instructions that, when executed by the at least one processor, cause the computing device to utilize a database of recognized user activities to determine the set of recognized user activities.

12. The non-transitory computer-readable medium of claim 10, further comprising instructions that, when executed by the at least one processor, cause the computing device to:
determine a set of recognized entities from subsets of recognized user activities from the set of recognized user activities; and
provide, for display within the graphical user interface of the application of the inter-network facilitation system, the set of recognized entities with the selectable element to initiate the integration of the risk assessment value.

13. The non-transitory computer-readable medium of claim 10, further comprising instructions that, when executed by the at least one processor, cause the computing device to provide, for display within a graphical user interface comprising a list of user activities, one or more recognized activity indicators adjacent to one or more user activities in the list of user activities for user activities determined as recognized on the risk assessment value generator of the third-party risk assessment system.

14. The non-transitory computer-readable medium of claim 10, further comprising instructions that, when executed by the at least one processor, cause the computing device to:
identify a particular user interaction that is a recognized user activity; and
in response to identifying the particular user interaction, provide, for display, an option to utilize user account information of the inter-network facilitation system to complete the user interaction within a third-party platform to utilize the user interaction as the recognized user activity on the risk assessment value generator of the third-party risk assessment system.

15. The non-transitory computer-readable medium of claim 10, further comprising instructions that, when executed by the at least one processor, cause the computing device to provide, for display within the graphical user interface of the application of the inter-network facilitation system, the user risk assessment value from the risk assessment value generator of the third-party risk assessment system.

16. A system comprising:
at least one processor; and
at least one non-transitory computer-readable storage medium storing instructions that, when executed by the at least one processor, cause the system to:
determine, from a set of user activities of a user account corresponding to an inter-network facilitation system, a set of recognized user activities recognized on a risk assessment value generator of a third-party risk assessment system;
provide, for display within a graphical user interface of an application of the inter-network facilitation system, the determined set of recognized activities with a selectable element to initiate an integration of a risk assessment value from the third-party risk assessment system with the user account of the inter-network facilitation system;
upon receiving a user interaction with the selectable element to enroll, integrate, within the application of the inter-network facilitation system, an additional user account from the third-party risk assessment system with the user account corresponding to the inter-network facilitation system; and
provide the set of user activities to the third-party risk assessment system to generate a user risk assessment value for the user account based on the risk assessment value generator of the third-party risk assessment system.

17. The system of claim 16, further comprising instructions that, when executed by the at least one processor, cause the system to utilize a machine learning model to determine the set of recognized user activities.

18. The system of claim 16, further comprising instructions that, when executed by the at least one processor, cause the system to utilize a database of recognized user activities to determine the set of recognized user activities.

19. The system of claim 16, further comprising instructions that, when executed by the at least one processor, cause the system to provide, for display within a graphical user interface comprising a list of user activities, one or more recognized activity indicators adjacent to one or more user activities in the list of user activities for user activities determined as recognized on the risk assessment value generator of the third-party risk assessment system.

20. The system of claim 16, further comprising instructions that, when executed by the at least one processor, cause the system to:
determine a set of recognized entities from subsets of recognized user activities from the set of recognized user activities; and
provide, for display within the graphical user interface of the application of the inter-network facilitation system, the set of recognized entities with the selectable element to initiate the integration of the risk assessment value.
